(19) United States
(12) Patent Application Publication
(10) Pub. No.: US 2016/0164975 A1
(43) Pub. Date: Jun. 9, 2016

(54) METHOD AND APPARATUS FOR MASHING UP HETEROGENEOUS SENSORS, AND RECORDING MEDIUM THEREOF

(71) Applicant: Korea Institute of Science and Technology, Seoul (KR)

(72) Inventors: Daeil SEO, Seoul (KR); Byounghyun YOO, Seoul (KR); Heedong KO, Seoul (KR)

(73) Assignee: Korea Institute of Science and Technology, Seoul (KR)

(21) Appl. No.: 14/693,225

(22) Filed: Apr. 22, 2015

(30) Foreign Application Priority Data
Dec. 3, 2014 (KR) 10-2014-0171946

(51) Int. Cl. H04L 29/08; G06F 17/21; G06F 17/30

(52) U.S. Cl. CPC H04L 67/125; H04L 67/22; G06F 17/30569; G06F 17/30598; G06F 17/218

(57) ABSTRACT

Disclosed is a method for mashing up heterogeneous sensors, which includes collecting an activity log from at least one sensor, converting the collected activity log into a common markup format, extracting an activity of a user from the activity log, based on an activity model which defines relations among activities, and outputting the extracted activity of the user in a semantic unit. Thus, it is possible to integrally utilize information of heterogeneous sensors, provide meaningful and intuitive information to a user, and share information of various applications and devices.

### CROSS-REFERENCE TO RELATED APPLICATION

This application claims priority to Korean Patent Application No. 2014-0171946, filed on Dec. 3, 2014, and all the benefits accruing therefrom under 35 U.S.C. §119, the contents of which in its entirety are herein incorporated by reference.

### BACKGROUND

1. Field

The present disclosure relates to a method and apparatus for mashing up heterogeneous sensors, and a recording medium thereof, and more particularly, to a method and apparatus for mashing up heterogeneous sensors, by which logs generated by various sensors are integrated and used, and a recording medium thereof.

2. Description of the Related Art

With the advent and widespread development of wearable computing, human activity monitoring has become ubiquitous in healthcare devices and smart phones. People use wearable physical sensors to collect activity logs and record their activities in social network services by posting their status, taking a media, or checking in a place.

Recently, small and lightweight sensors and devices have been explosively popular, and smart phones also have various embedded sensors and mobile applications for tracking personal activities. With the popularity of mobile applications and wearable devices, there has been a proliferation of personal activity log data, and the necessity of a method of managing such data is inevitable.

Meanwhile, log information generated in various ways has different features depending on characteristics of each device, the kinds of sensors and a form of a social media. For example, in case of a wearable device, only information essentially required for the device is logged due to a small size, capacity and battery of the portable device. Also, in case of logging information using a smart phone, even though the smart phone has more sensors in comparison to a wearable device, it is seldom to use all the sensors due to its battery.

In addition, since logging is performed using various applications, it has been proposed to share data among various applications or devices or to share unrecorded logging information among them. However, these methods just share logging information, and logging information recorded in a social media is not considered.

For example, commercial healthcare and tracking services (for example, Garmin Connect, Fitbit and Withings) provide visualization for statistical data analysis and application programming interfaces (APIs) to share and integrate activity records with other service providers. However, these services are supported only with their products and the log notations are tailored to each service's objective. As a result, it is difficult to integrate activity logs from various sources, and existing healthcare mash-up services merely show a summary list of activity logs.

For this reason, connected activity logs across heterogeneous wearable devices are emerging to avoid functional redundancy and to extend functionality of activity monitors. However, the functions and features of wearable devices contain too much data to yield meaningful information. Thus, there is strong demanded for a method for enriching complementary data that considers features of heterogeneous sensors and mobile applications.

### SUMMARY

The present disclosure is directed to providing a method for mashing up heterogeneous sensors, which may record activities of a user by using logs collected from various sensors.

The present disclosure is also directed to providing a recording medium in which a computer program for performing the method for mashing up heterogeneous sensors is recorded.

The present disclosure is also directed to providing an apparatus for performing the method for mashing up heterogeneous sensors.

In one aspect, there is provided a method for mashing up heterogeneous sensors, which includes: collecting an activity log from at least one sensor; converting the collected activity log into a common markup format; extracting an activity of a user from the activity log, based on an activity model which defines relations among activities; and outputting the extracted activity of the user in a semantic unit.

In an embodiment of the present disclosure, the extracting of an activity of a user from the activity log may include: rearranging the activity log in a time order; and selecting a representative activity of the user from an activity log coexistent in the same time zone.

In an embodiment of the present disclosure, in the selecting of a representative activity of the user from an activity log coexistent in the same time zone, when at least two activity logs are generated in the same time zone, a representative activity may be selected according to a priority order, which is determined as a criterion for selection of a representative activity.

In an embodiment of the present disclosure, the selecting of a representative activity of the user from an activity log coexistent in the same time zone may include determining whether activities corresponding to the at least two activity logs are complementary or mutually exclusive.

In an embodiment of the present disclosure, in the extracting of an activity of a user from the activity log, when the activities are complementary, the activities may be selected as the representative activity and a subsidiary activity of the representative activity.

In an embodiment of the present disclosure, the collecting of an activity log from at least one sensor may include classifying the collected activity log according to a sensor model in which a sensor relationship is defined according to a level of log information.

In an embodiment of the present disclosure, the sensor model may classify the sensor into a physical sensor, an activity sensor and a social sensor.

In an embodiment of the present disclosure, in the collecting of an activity log from at least one sensor, an activity log may be collected periodically from the sensor or collected whenever an activity log is generated from the sensor.

In an embodiment of the present disclosure, in the collecting of an activity log from at least one sensor, information input by the user may be collected.

In an embodiment of the present disclosure, the converting of the collected activity log into a common markup format may use a markup model defining a common markup format.

In an embodiment of the present disclosure, the method for mashing up heterogeneous sensors may further include storing the activity log converted into the common markup format.

In an embodiment of the present disclosure, the at least one sensor may include at least one of a wearable device, a mobile device, a sensor attached to or included in a wearable device or a mobile device, an application installed at a wearable device or a mobile device, a terminal communicating with a wearable device or a mobile device, a sensor attached to or included in a terminal communicating with a wearable device or a mobile device, and an application installed at a terminal communicating with a wearable device or a mobile device.

In an embodiment of the present disclosure, the method for mashing up heterogeneous sensors may further include displaying the output activity of the user in a semantic unit.

In an embodiment of the present disclosure, in the displaying of the output activity of the user in a semantic unit, the output activity may be displayed in association with a corresponding application or by means of virtual reality or augmented reality.

In another aspect of the present disclosure, there is provided a computer program, recorded in a recording medium for performing the method for mashing up heterogeneous sensors.

In another aspect of the present disclosure, there is provided an apparatus for mashing up heterogeneous sensors, which includes: an information collection unit configured to collect an activity log from at least one sensor; a conversion unit configured to convert the collected activity log into a common markup format; an activity management unit configured to extract an activity of a user from the activity log, based on an activity model which defines relations among activities; and an output unit configured to output the extracted activity of the user in a semantic unit.

In an embodiment of the present disclosure, the activity management unit may rearrange the activity log in a time order and select a representative activity of the user from an activity log coexistent in the same time zone.

In an embodiment of the present disclosure, when at least two activity logs are generated in the same time zone, the activity management unit may select a representative activity of the user according to a priority order, which is determined as a criterion for selection of a representative activity, and according to whether activities corresponding to the at least two activity logs are complementary or mutually exclusive.

In an embodiment of the present disclosure, when the activities are complementary, the activity management unit may select the activities as the representative activity and a subsidiary activity of the representative activity.

In an embodiment of the present disclosure, the information collection unit may classify the collected activity log according to a sensor model in which a sensor relationship is defined according to a level of log information.

In an embodiment of the present disclosure, the sensor model may classify the sensor into a physical sensor, an activity sensor and a social sensor.

In an embodiment of the present disclosure, the information collection unit may collect an activity log from the sensor periodically or whenever an activity log is generated from the sensor.

In an embodiment of the present disclosure, the information collection unit may collect information input by the user.

In an embodiment of the present disclosure, the conversion unit may convert the collected activity log into a common markup format by using a markup model defining a common markup format.

In an embodiment of the present disclosure, the apparatus for mashing up heterogeneous sensors may further include a database configured to storing the activity log converted into the common markup format.

In an embodiment of the present disclosure, the at least one sensor may include at least one of a wearable device, a mobile device, a sensor attached to or included in a wearable device or a mobile device, an application installed at a wearable device or a mobile device, a terminal communicating with a wearable device or a mobile device, a sensor attached to or included in a terminal communicating with a wearable device or a mobile device, and an application installed at a terminal communicating with a wearable device or a mobile device.

In an embodiment of the present disclosure, the apparatus for mashing up heterogeneous sensors may further include a display unit configured to display the output activity of the user in a semantic unit.

In an embodiment of the present disclosure, the display unit may display the output activity in association with a corresponding application or by means of virtual reality or augmented reality.

If the method and apparatus for mashing up heterogeneous sensors and the recording medium thereof are used, logs of heterogeneous sensors may be expressed through a common data schema, and relationship between activities may be determined according to an activity mash-up model. In addition, since the generated activities may be interpreted and managed in view of an individual user, it is possible to provide an integrated ubiquitous environment to the user. Further, a personal activity model suitable for an individual user may be configured by means of personal pattern learning according to activity and sensor using pattern of the user, and it is also possible to provide personally-customized health management service and inform problems by utilizing the personal activity model.

### BRIEF DESCRIPTION OF THE DRAWINGS

FIG. 1 is a block diagram showing an apparatus for mashing up heterogeneous sensors according to an embodiment of the present disclosure.

FIG. 2 is a diagram showing an example of a sensor model according to the present disclosure.

FIG. 3 is a diagram showing an example of an activity model according to the present disclosure.

FIG. 4 is a diagram for illustrating an operation of the apparatus for mashing up heterogeneous sensors, depicted in FIG. 1.

FIGS. 5A and 5B are diagrams for illustrating a criterion for determining a representative activity in the activity model according to the present disclosure.

FIG. 6 is a flowchart for illustrating a method for mashing up heterogeneous sensors according to an embodiment of the present disclosure.

### DETAILED DESCRIPTION

The following detailed description of the present disclosure refers to the accompanying drawings which show specific embodiments implemented by the present disclosure. These embodiments are described in detail so as to be easily implemented by those skilled in the art. It should be understood that various embodiments of the present disclosure are different from each other but not exclusive from each other. For example, specific shapes, structures and features written herein can be implemented in other embodiments without departing from the scope of the present disclosure. In addition, it should be understood that locations or arrangements of individual components in each embodiment may be changed without departing from the scope of the present disclosure. Therefore, the following detailed description is not directed to limiting the present disclosure, and the scope of the present disclosure is defined just with the appended claims along and their equivalents, if it is suitably explained. In the drawings, like reference numerals denote like elements through several drawings.

Hereinafter, embodiments of the present disclosure will be described in detail with reference to the accompanying drawings.

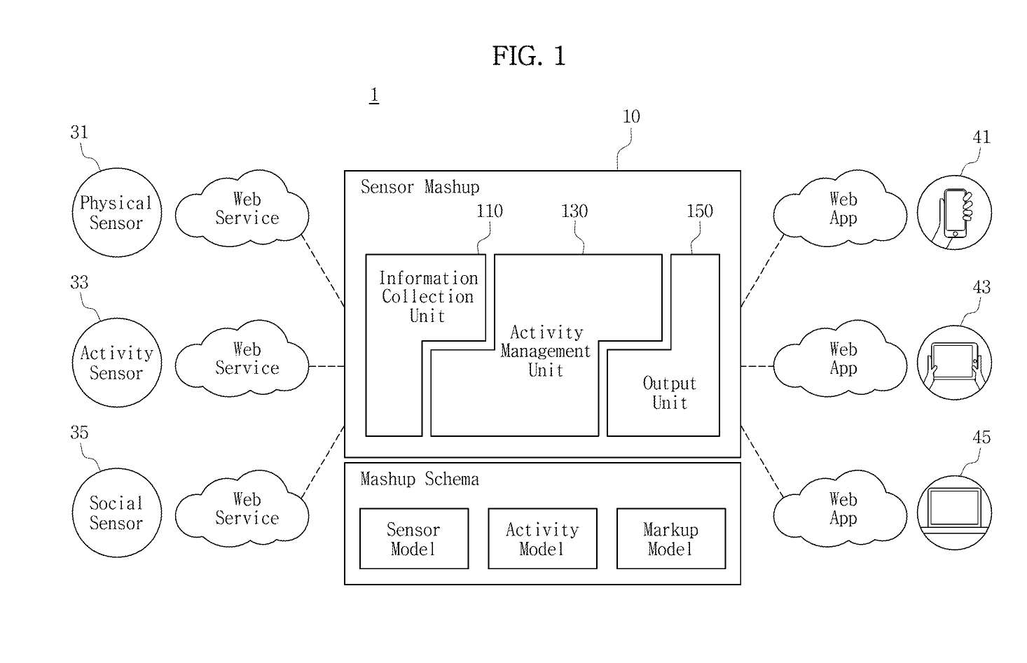

FIG. 1 is a block diagram showing an apparatus for mashing up heterogeneous sensors according to an embodiment of the present disclosure.

An apparatus 10 for mashing up heterogeneous sensors (hereinafter, also referred to as an apparatus) according to the present disclosure provides a mash-up framework for collecting logging information of a user from sensors 31, 33, 35 surrounding the user, expressing an activity of the user based thereon, and transmitting the activity in a semantic unit through terminals 41, 43, 45 of the user. In FIG. 1, an entire system 1 for mashing up heterogeneous sensors, which includes the apparatus 10, is depicted.

For example, a wearable device worn by the user functions as the sensors 31, 33, 35, a separate server functions as the apparatus 10 for mashing up heterogeneous sensors, and a mash-up result of the heterogeneous sensors may be provided to a mobile device of the user.

Meanwhile, the apparatus 10, the sensors 31, 33, 35 and the terminals 41, 43, 45 of the user may be actually included in a single terminal. For example, an activity log may be collected through a sensor included in a smart phone of a user, an internal module of the smart phone serves as the apparatus 10 for mashing up heterogeneous sensors, and a mash-up result of the heterogeneous sensors may be provided through a display of the smart phone.

The sensors 31, 33, 35 may include at least one of a wearable device, a mobile device, a sensor attached to or included in a wearable device or a mobile device, an application installed at a wearable device or a mobile device, a terminal communicating with a wearable device or a mobile device, a sensor attached to or included in a terminal communicating with a wearable device or a mobile device, and an application installed at a terminal communicating with a wearable device or a mobile device.

The apparatus 10 may employ various kinds of mobile devices such as smart phones, cellular phones, tablet computers, netbooks, PDA, PMP or the like, or a module thereof. In addition, the apparatus 10 for mashing up heterogeneous sensors may also be in a form of a server or engine, or a module thereof.

In addition, the apparatus 10 may execute various application programs based on an operation system (OS). The operation system is a system program for allowing any application program to use hardware of a computer and may employ any kind of operation system loaded on a mobile terminal, for example iOS, Android OS, Windows mobile OS, Bada OS, Simbian OS, Blackberry OS or the like.

The application program is developed to perform a specific work using a computer and may employ various kinds of applications as well as various multimedia contents or execution programs of image viewers or moving picture regenerators for the various multimedia contents.

Referring to FIG. 1, the apparatus 10 according to the present disclosure includes an information collection unit 110, a conversion unit (not shown), an activity management unit 130 and an output unit 150. The apparatus 10 may further include a display unit (not shown). The conversion unit may be configured separately from other components of the apparatus 10 or be configured as a part of the information collection unit 110 or the activity management unit 130.

Software (or, an application) for supporting mashing-up of heterogeneous sensors may be installed and executed at the apparatus 10 of the present disclosure, and each component of the apparatus 10 may be controlled by the software for supporting mashing-up of heterogeneous sensors. In addition, the components of the apparatus 10 may be integrated into a single module or formed as individual modules.

The apparatus 10 refer to a mash-up schema in order to collect logging information from heterogeneous sensors and transmit meaningful information to the user, and the mash-up schema may include a sensor model, an activity model and a markup model.

These models are formed hierarchically, and it is possible to specifically use models already constructed or the user may update the models by adding, deleting or modifying them.

The sensor model may define a relationship of a sensor according to a level of log information. In the present disclosure, information input by the user and data extracted from the information may be used along with the activity logs automatically collected through a device or a sensor included the device. In addition, the user may select a sensor which is to collect a log.

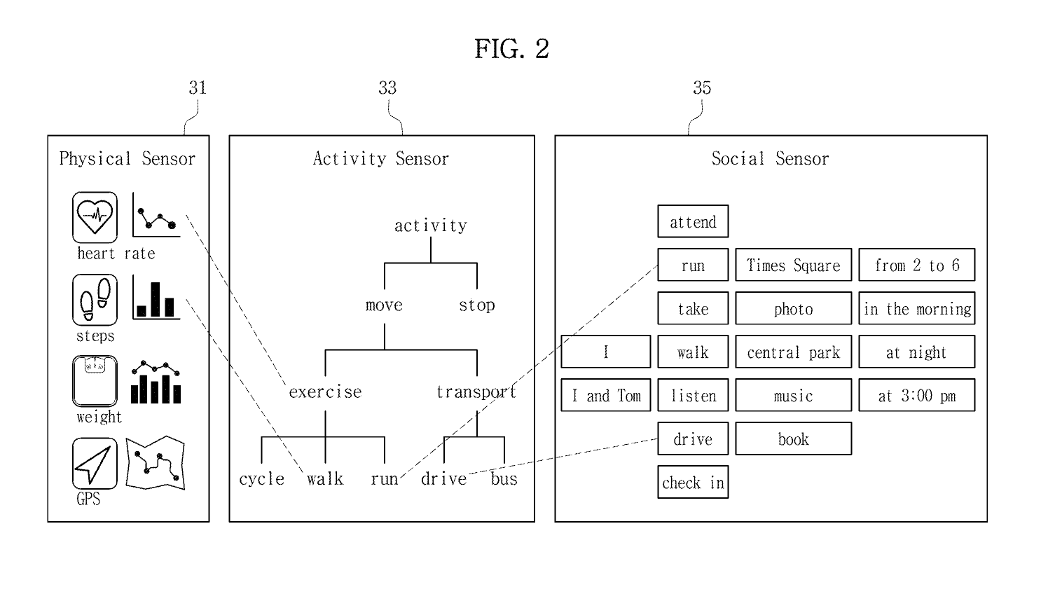

Referring to FIG. 2, resources for monitoring activities of a human according to an embodiment of the present disclosure are classified into three sensor types, namely a physical sensor 31, an activity sensor 33 and a social sensor 35.

The physical sensor 31 collects information such as a heart rate, the number of steps, a weight, a GPS signal or the like as fundamental raw data according to an activity of the user. The information may be collected periodically or whenever an activity of the user is generated.

The commercial wearable device, for example Fitbit, Jawbone Up, or the like, stores data in a server of a manufacturer connected thereto, and the raw data collected from the physical sensor may be provided in a summary form through the server.

The activity sensor 33 recognizes a human activity from the physical sensor. For example, an activity monitoring application of a smart phone or a dedicated smart phone application may be used for a wearable device which recognizes an activity from data of the physical sensor. For example, Moves application divides sensor data and classifies a motion activity by means of feature extraction. In addition, a server of a commercial physical sensor summarizes a log of the raw data provided from the physical sensor into an activity log.

The social sensor 35 recognizes a log of a daily life included in a social media such as Facebook and Foursquare, including additional information such as place and time of the activity. For example, the user may record music listening and reading and share the same with other persons in a social network service. Different from this, the social sensor may also fuse various kinds of information collectable from the physical sensor or the activity sensor to obtain new information.

In the present disclosure, the sensor model schemas as shown in Table 1 below may be used in order to express various sensors into three types defined above, based on the information of the sensors.

TABLE 1

| Property | Description | Example |
|---|---|---|
| typeId | Unique identifier | http://example.com/sensor/fitbit |
| | of sensor type | |
| displayName | Display name of | Fitbit |
| | the sensor | |
| description | Description of | Fitbit sensor for tracking activities |
| | the sensor | |
| readings | Define sensor | [{“http://example.com/reading/steps”, |
| | reading types | “count”}. {“http://example.com/ |
| | and units of | reading/distance”, “km”}, ...] |
| | measure | |

Each sensor has a sensor ID as an identifier for distinguishing the sensor and may give detailed description about a sensor name and a sensor explanation by using a description attribute and define a range of log information collectable by individual sensors as readings. The description may be expressed with JSON or XML, and the application provides information for reconstructing an activity log collected from a sensor according to an activity model.

The activity model defines relationship among activities in order to recognize and summarize activities collected by using the sensor model. The activity model proposed in the present disclosure provides an activity log by means of various subdivisions using hierarchical relations among activities.

In detail, the activity model is used as a criterion for classifying the sensors according to their functions and integrating activities collected from the sensors. By doing so, activities are integrated and hierarchically classified according to the relationships among activities, and thus information from a summary about an activity to raw data collected from a sensor may be provided to the user. In addition, activity logs collected from various sensors having the same function at the same time may also be processed.

The activity model may be differently configured depending on an application area or a purpose of the application. The activity model defines attributes as in Table 2 below in order to define relationships among activities suitable for the application by using the sensor model.

TABLE 2

| Property | Description | Example |
|---|---|---|
| activityId | Unique identifier of activity | http://example.com/activity/walk |
| | type | |
| displayName | Display name of the activity | Walk |
| description | Description of the activity | Walking activity |
| childActivities | Subsidiary activities of the | [“http://example.com/activity/steps”, ...] |
| | activity | |
| mutuallyExclu- | Conflicting activities of the | [“http://example.com/activity/run”, |
| siveActivities | activity that cannot be | “http://example.com/activity/cycle”, |
| | occurred simultaneously | “http://example.com/activity/drive”, ...] |
| readings | Associated sensor reading | [“http://example.com/reading/steps”, |
| | types of activity | “http://example.com/reading/gps”, |
| | | “http://example.com/reading/distance”, |
| | | “http://example.com/reading/calories”, ...] |

Each activity has an activity ID as an identifier and defines a function of the sensor model. The activity name represents a general name of the activity and provides detailed information of the corresponding activity by using a description attribute. The activity provides extraction information to an upper-level activity if a children activity is satisfied, and activities of upper and lower ranks may be defined through the children activity. Activities which are mutually exclusive define activities which cannot be generated at the same time, and the information of the activity is used when an activity of a user is summarized and provided through the activity management unit 130.

The activity model may use JSON or XML, and each activity type may have a URI as an inherent identifier or have an expressed name attribute as a user-friendly name The children activity and the mutually exclusive activities define relationships among activities, and the read attribute refers to a sensor type which collects and visualizes an activity log.

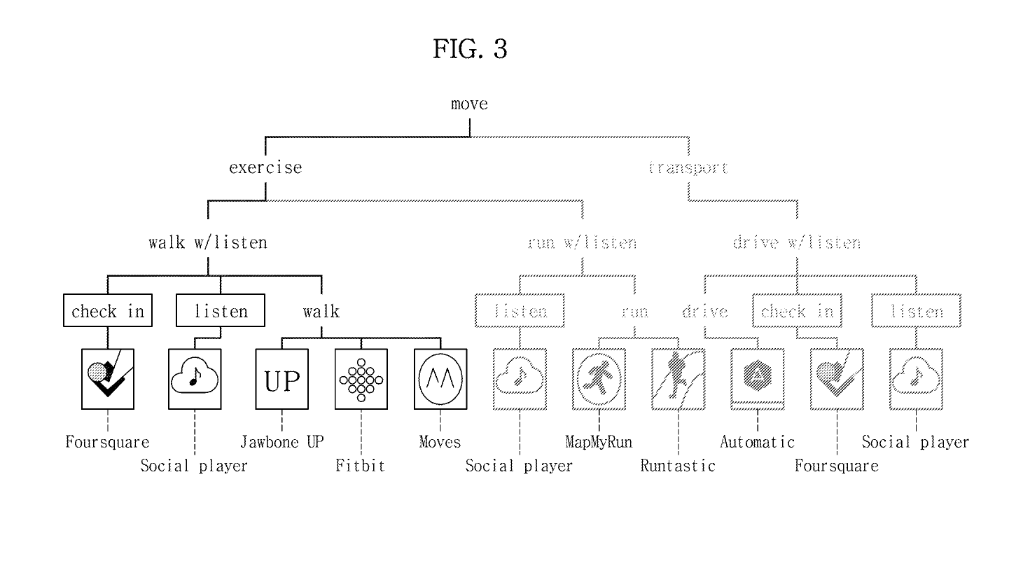

FIG. 3 shows an example of an activity model proposed for a healthcare application, which is based on a classification of human body activities. In FIG. 3, an exercise activity includes children activities (for example, walking and running), and the walking activity has subsidiary social activities (for example, check in or listen) recognized by the social sensor. For example, the walking activity is recognized by an activity sensor such as a Fitbit application which collects data from a physical sensor (namely, a Fitbit wearable device) and a Moves application which uses a sensor in the smart phone.

The activity management unit 130 interprets the activity log based on the activity model. For the activity management unit 130 to interpret the activity log by using the activity model, a new markup model for the activity model is required.

The markup model defines the activity log as a common markup format. The activity logs collected from heterogeneous sensors use different notations according to sensor providers, and thus a common activity markup language for various activity logs is required. For example, as a notation which is abundant, human-friendly, machine-readable and expandable, Activity Streams may be used. In Activity Streams, an activity entity provides metadata about a latent or completed motion. Table 3 below shows examples of attributes selected in Activity Streams employed by the present disclosure.

TABLE 3

| Property | Example |
|---|---|
| id | http://example.com/alice/log/activity/walk/1 |
| actor | http://example.com/alice |
| provider | http://example.com/sensor/moves |
| verb | http://example.com/activity/walk |
| displayName | Walk |
| result | [{“http://example.com/reading/steps”, 14594}, |
| | {“http://example.com/reading/distance”, 10.34}] |
| location | Yeouido Hangang Park |
| startTime | 2014-05-23T12:23:12Z |
| endTime | 2014-05-23T13:25:15Z |
| Object | |
| ObjectType | http://example.com/object/audio |
| MediaType | audio/mpeg |
| url | http://example.com/object/audio/2 |
| displayName | Love Never Felt So Good/Michael Jackson |

The activity log is identified with an ID attribute and a manufacturer attribute. The manufacturer attribute represents a sensor type ID of a sensor model which reveals an activity (for example, Fitbit, Moves, Facebook). A verb attribute represents a type of an activity and an activity ID of the activity. A start time attribute (startTime) and an end time attribute (endTime) represent actual or expected start and end times of the activity. The location attribute represents at least one physical place associated with the activity. A sensor reading a value of the verb attribute or an activity result records a result attribute.

The object attribute represents a direct target or a detailed result of an activity. The object attribute represents a URL resource having a detail log collected by the physical sensor and the activity sensor, and the media type attribute (mediaType) represents a resource type on the web.

The following is an example of an activity log representing Activity Streams in a JSON format.

{ totalItems,
items: [id, actor, provider, verb, displayName, (result),
startTime, endTime, (location),
object: [objectType, mediaType, url, (displayName)], ... ], ... }

A left branch node of FIG. 3 is composed of five kinds of sensors, among which three sensors (Jawbone Up, Fitbit and Moves) provide the same information. For example, distance and step number logs about a walking activity are obtained from Moves, which is an activity sensor, and information about start and end points are input through Foursquare, which is a social sensor. In addition, information about music which has been listened while walking is recorded in a social sensor, which is a social player. By doing so, five kinds of activity logs are recorded, summary information about the activity is generated as metadata of Activity Streams, and values of all identifiers recorded with Activity Streams are classified with URL. Detailed log information about the activity is expressed as an object attribute with URL.

The apparatus 10 collects logging information from heterogeneous sensors with reference to the sensor model, the activity model and the markup model, which are defined, and transmits meaningful information to the user. For example, in order to provide enriched personal healthcare activity logging, a process of collecting information of individual sensors of the user from each service in terms of the user is required, and a process of extracting and reconstructing activities according to whether the activities are complementary or mutually exclusive is performed. In addition, a personal healthcare activity log generated from the above is visualized so as to be understood by the user.

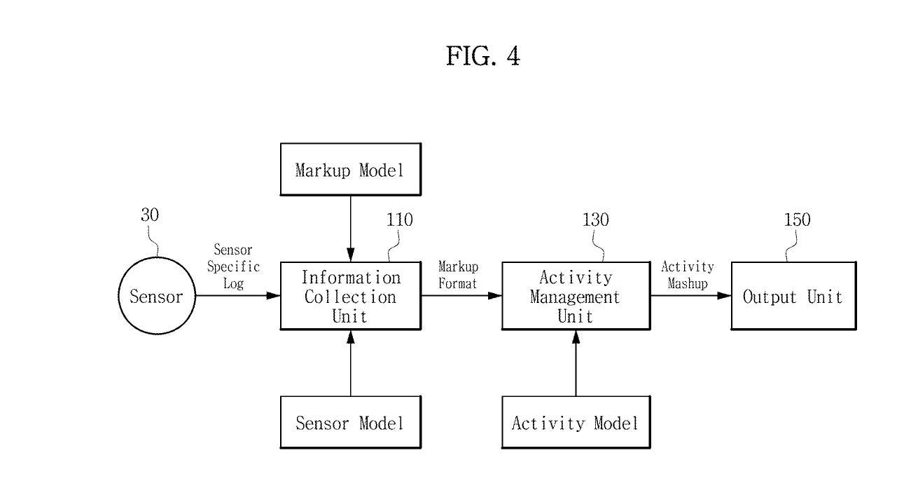

Referring to FIG. 4, the information collection unit 110 collects an activity log from at least one sensor 30. The information collection unit 110 may collect activity logs from the sensor 30 periodically or whenever an activity log is generated from the sensor 30. In addition, the information collection unit 110 may also collect information manually input by the user.

The information collection unit 110 classifies the collected activity log with reference to the sensor model and converts the collected activity log into the common markup format with reference to the markup model.

The data collected from the sensor is recorded and stored in the service provided by each individual sensor seller, and the corresponding data may be accessed using a corresponding application. This service provides two kinds of sensor logs, and a raw log collected from the physical sensor and an activity log formed by extracting or summarizing the raw log based on space and time information by means of the activity sensor are provided.

The information collection unit 110 may get a raw log and an activity log periodically through user authentication by using account information about the sensor of the user. The information collection unit 110 classifies logs collected from the sensor according to the type of the sensor with reference to the sensor model, and among the sensor log information, the raw log is stored in a data format defined by the service provider and the activity log is stored in a common markup format.

By doing so, sensor information according to the sensor model is extracted and forms a foundation for meaningful activity log mash-up. As a result, the activity management unit 130 may process an activity log having an interoperable semantic format, instead of a specific format of a producer based on the activity model.

The activity management unit 130 extracts an activity of the user from the activity log collected from the sensor, based on the activity model defining relationships among activities.

In detail, the activity management unit 130 recognizes activities from the activity log stored in the common markup format according to a time sequence for mash-up. Due to a sensor use pattern of the user, a plurality of activities may happen simultaneously. The activity management unit 130 selects a representative activity of the user based on the activity model and the activity relationship. The activity relationship may be a complementary relationship or a mutually exclusive relationship.

The activity management unit 130 classifies the logs into a dynamic activity and a static activity by using time and space metadata. For example, the dynamic activity may be an activity performed by the user such as walking, running and driving, and the static activity may be an activity regardless of movement of the user such as stopping, listening, reading and seeing.

The activity management unit 130 rearranges the activity logs collected from the information collection unit 110 in a time order, and if two or more activities are duplicated at the same time, a representative activity is selected according to a relationship among activity logs based on the activity model and a criterion for selection of a representative activity.

First, it is determined whether activities corresponding to at least two activity logs generated in the same time zone are complementary or mutually exclusive. If the activities are complementary, a representative activity is selected according to the representative activity selection criterion, and other activities are selected as subsidiary activities of the representative activity. Meanwhile, if the activities are mutually exclusive, a single representative activity is selected according to the representative activity selection criterion.

The activity management unit 130 may apply the representative activity selection criterion subsequently determined, and if there is a criterion defined by the user, the criterion defined by the user may have priority to the determined criterion. The followings are examples of the representative activity selection criterion.

1. If activity logs having the same function are collected from two or more sensors, an activity log collected from a more precise sensor has priority.

2. If an activity pattern is iterative and an activity of this pattern has a longer duration than other activities, an activity pattern having a longer duration has priority

3. If an activity region includes other activity regions, an activity corresponding to the activity region includes other activity regions has priority.

4. A dynamic activity has priority to a static activity. However, if the static activity has a longer duration than the dynamic activity, the static activity has priority

5. An activity demanding metabolic equivalent (MET) due to establishment of a physical activity has priority.

6. If two or more duplicated activities have the same priority, an activity starting earlier has priority

7. A display name attribute (displayName) of the representative activity is determined as “representative activity displayName w/other activities' displayName” (for example, “walk w/listen”). If an upper-rank activity is defined, the name is determined as “upper activity by subsidiary activities” (for example, “exercise by walking, running”).

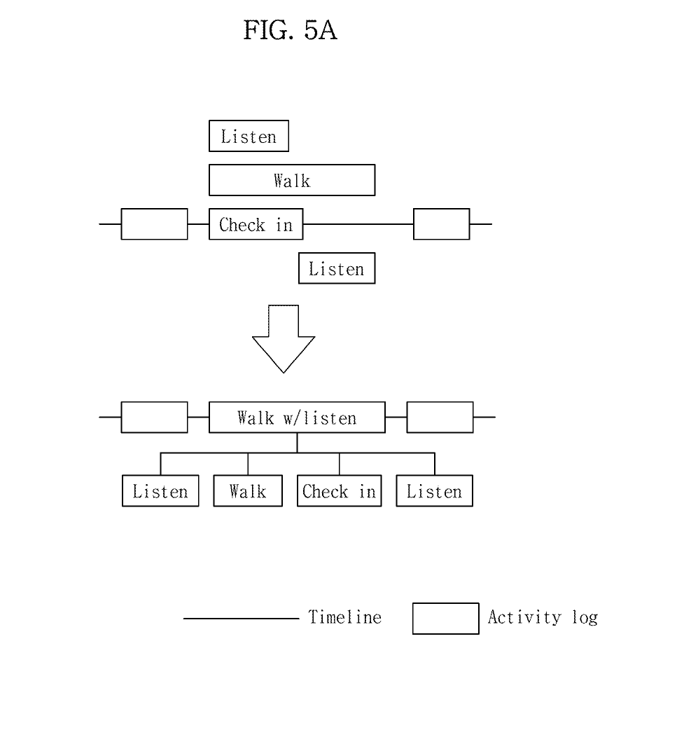

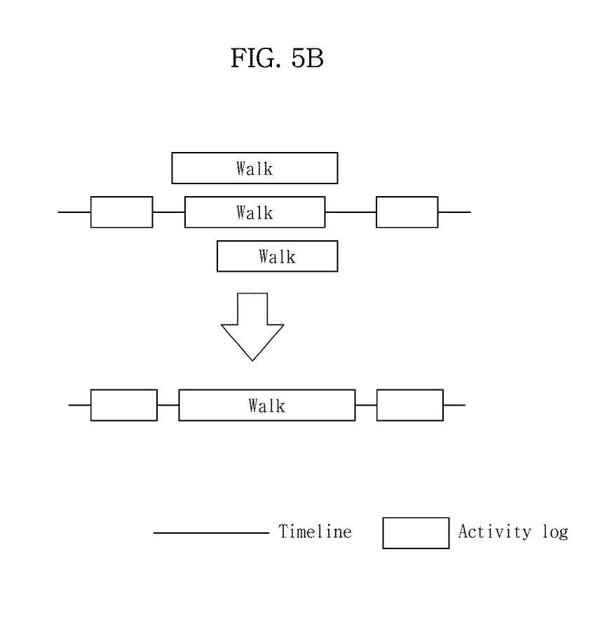

For example, referring to FIG. 5A, a user may walk while listening to music. Sensors such as Jawbone Up, Fitbit and Moves have the same function of detecting a walking activity. Activity start and end places are logged by a social sensor such as Foursquare. In addition, a social sensor such as a social player posts music information when the user listens to music while walking. Such logs may be checked with an ID attribute using a URI notation.

Since the user may perform walking, listening and checking-in activities simultaneously, the activities may be complementary without being mutually exclusive. The activity management unit 130 may select a walking activity as a representative activity based on the representative activity selection criterion and the activity model (see FIG. 3). Other activities become subsidiary activities as shown in FIG. 5A.

The following is an example of recording the activity log according to a notation of Activity Streams by the activity management unit 130, based on the activity model depicted in FIG. 5A.

{ totalItems,
items: [objectType, id, actor, displayName, (location),
startTime, endTime,
actions: [id, verb, (object | result)], ... ], ... }

If the activities are complementary, the activity notation becomes a summary of the representative activity having time and space information, and the subsidiary activities are added below the representative activity.

Meanwhile, since the user cannot perform walking and running activities at the same time, these activities are mutually exclusive. In addition, if sensors have the same performance, they are mutually exclusive as shown in FIG. 5B and FIG. 3. In this case, the activity model may select one of the activities as a representative activity and request the user to decide whether the selected activity is a representative activity or not.

If the representative activity is selected improperly, the activity management unit 130 endows a low weight to its own selection, and the activity selected by the user is used as the representative activity. In addition, if the mash-up result of the activity management unit 130 is different from the user's expectation, the user may manually reconfigure a mash-up result.

The output unit 150 expresses the extracted activity of the user in a semantic unit. The output unit 150 may output a result of the mash-up activities collected by the activity management unit 130 through the display unit so that the result is visualized.

The display unit may provide a user interface and show activities of the user in a time order. For example, activities of the user may be hierarchically displayed, and when the user selects a specific activity, information of the corresponding activity may be displayed. In addition, if the selected activity is a representative activity, lower-rank activities may be displayed.

The output unit 150 may visually show activity description by using a table or map through the display unit, based on activity features, provide an application, a recommended service or the like associated with the result of the mash-up activity, and provide a visual sign by means of virtual reality and augmented reality to give a possibility of intuitive recognition to the user.

The output unit 150 expresses time and space information mainly according to the kind and time of the activity selected by the user. The activity is expressed according to a time order, and if there is space information, a start point, an end point and an intermediate point may be expressed using a map. Icons may be used for showing a type of the activity or the sensor.

As described above, the present disclosure may be usefully utilized to provide a common format for logging of heterogeneous sensors and gain a meaningful insight for execution of a prototype. The activity mash-up model proposed in the present disclosure may provide a framework for a personal pattern which is learned by accumulated sensor data collected from an activity monitoring device and an Internet of Things (IoT) device. In addition, through personal pattern learning for a user behavior and a sensor use pattern, a personal activity model suitable for an individual user may be configured, and this may be utilized to manage personally customized healthcare and inform problems.

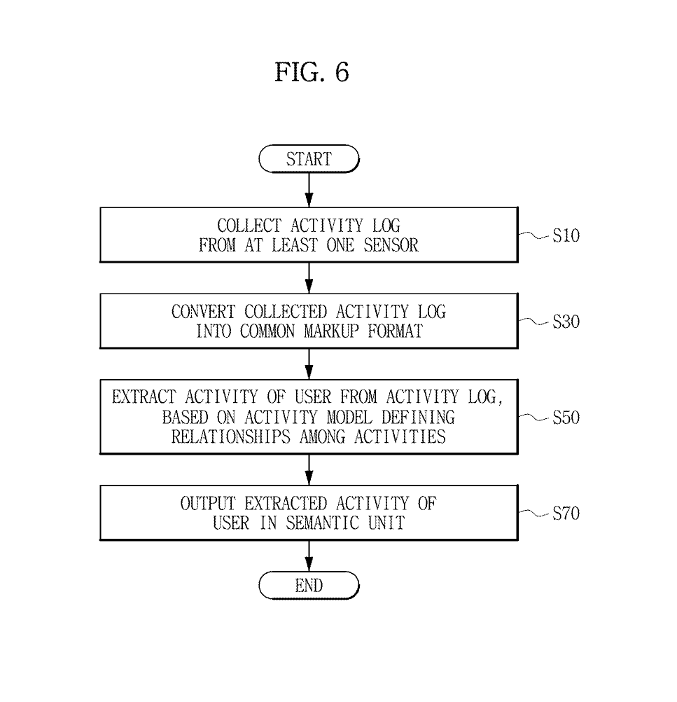

FIG. 6 is a flowchart for illustrating a method for mashing up heterogeneous sensors according to an embodiment of the present disclosure.

A method for mashing up heterogeneous sensors according to this embodiment may be performed using substantially the same configuration of the apparatus 10 of FIG. 1. Therefore, the same component of the apparatus 10 depicted in FIG. 1 is designated with the same reference symbol and is not described in detail here.

Or else, the method for mashing up heterogeneous sensors according to this embodiment may be performed using software (or, an application) for supporting mashing-up of heterogeneous sensors and visualization of a mash-up result.

Referring to FIG. 6, in the method for mashing up heterogeneous sensors according to this embodiment, an activity log is collected from at least one sensor (S10). Activity logs may be collected from the sensor periodically or whenever an activity log is generated from the sensor. In addition, information input by the user may also be collected.

At least one sensor may be at least one of a wearable device, a mobile device, a sensor attached to or included in a wearable device or a mobile device, an application installed at a wearable device or a mobile device, a terminal communicating with a wearable device or a mobile device, a sensor attached to or included in a terminal communicating with a wearable device or a mobile device, and an application installed at a terminal communicating with a wearable device or a mobile device.

The collected information is classified according to a sensor model which defines sensor relationships according to a level of log information. The sensor model may classify the sensor into a physical sensor, an activity sensor and a social sensor. The sensor model is hierarchically formed, and it is possible to specifically use models already constructed or the user may update the models by adding, deleting or modifying them.

If the activity log is collected, the collected activity log is converted into a common markup format (S30). This is performed with reference to a markup model defining the common markup format, and the activity log converted into the common markup format may be stored.

Since the activity logs collected from heterogeneous sensors use different notations according to sensor providers, a common activity markup language for various activity logs is required. For example, Activity Streams may be used as a notation for expressing an activity.

After the collected activity log is converted into the common markup format, an activity of the user is extracted from the activity log, based on an activity model defining relationships among activities (S50). The activity model defines a relationship among activities in order to recognize and summarize the activities collected by using the sensor model.

In S50 for extracting an activity of the user, the activity logs are rearranged in a time order, and a representative activity of the user is selected from an activity log coexistent in the same time zone.

If two or more activity logs are generated in the same time zone, the representative activity is selected according to priority determined by a representative activity selection criterion. The representative activity selection criterion is applied according to a predetermined order, and if there is a criterion defined by the user, the criterion defined by the user may have priority to the determined criterion.

In addition, it is determined whether activities corresponding to at least two activity logs are complementary or mutually exclusive, and if the activities are complementary, the activities are selected as the representative activity and subsidiary activities of the representative activity.

Further, the extracted activity of the user is output in a semantic unit (S70). In other words, a result of the collected mash-up activities may be expressed in a time order, and if the user selects an activity, activity description may be provided based on activity features by using a table or map. Accordingly, among abundant information, meaningful information may be provided to the user while excluding unnecessary information.

The output information of the semantic unit is visualized through the display unit of the terminal of the user, and a user interface may also be provided to the display unit. In addition, by using the display unit, activity description may be visually shown based on activity features by using a table or map, and an application, a recommended service or the like associated with the result of the mash-up activity may be provided. In addition, a visual sign may also be provided by means of virtual reality and augmented reality to give a possibility of intuitive recognition to the user.

The method for mashing up heterogeneous sensors may be implemented as an application or program commands executable by various kinds of computer means and recorded on a computer-readable recording medium. The computer-readable recording medium may include program commands, data files, data structures or the like solely or in combination.

The program commands recorded on the medium may be specially designed or configured for the present disclosure or known to and available by computer software engineers.

The computer-readable recording medium includes, for example, magnetic media such as a hard disk, a floppy disk and a magnetic tape, optical media such as CD-ROM and DVD, magneto-optical media such as a floptical disk, hardware devices such as ROM, RAM and a flash memory, specially configured to store and perform program commands, or the like.

The program commands include not only machine codes made by a complier but also high-level language codes executable by a computer by using an interpreter. The hardware device may be configured to operate as at least one software module to perform the operations of the present disclosure, or vice versa.

While the exemplary embodiments have been shown and described, it will be understood by those skilled in the art that various changes in form and details may be made thereto without departing from the spirit and scope of this disclosure as defined by the appended claims.

The method for mashing up heterogeneous sensors proposed in the present disclosure is expected to be utilized for managing individual healthy to provide personally-customized health management service and inform problems. Further, this method would be widely utilized for integrating information of heterogeneous sensors in various fields.

What is claimed is:

1. A method for mashing up heterogeneous sensors, comprising:
collecting an activity log from at least one sensor;
converting the collected activity log into a common markup format;
extracting an activity of a user from the activity log, based on an activity model which defines relations among activities; and
outputting the extracted activity of the user in a semantic unit.

2. The method for mashing up heterogeneous sensors according to claim 1, wherein said extracting of an activity of a user from the activity log includes:
rearranging the activity log in a time order; and
selecting a representative activity of the user from an activity log coexistent in the same time zone.

3. The method for mashing up heterogeneous sensors according to claim 2,
wherein, in said selecting of a representative activity of the user from an activity log coexistent in the same time zone, when at least two activity logs are generated in the same time zone, a representative activity is selected according to a priority order, which is determined as a criterion for selection of a representative activity.

4. The method for mashing up heterogeneous sensors according to claim 3,
wherein said selecting of a representative activity of the user from an activity log coexistent in the same time zone includes:
determining whether activities corresponding to the at least two activity logs are complementary or mutually exclusive.

5. The method for mashing up heterogeneous sensors according to claim 4,
wherein, in said extracting of an activity of a user from the activity log, when the activities are complementary, the activities are selected as the representative activity and a subsidiary activity of the representative activity.

6. The method for mashing up heterogeneous sensors according to claim 1,
wherein said collecting of an activity log from at least one sensor includes:
classifying the collected activity log according to a sensor model in which a sensor relationship is defined according to a level of log information.

7. The method for mashing up heterogeneous sensors according to claim 6,
wherein the sensor model classifies the sensor into a physical sensor, an activity sensor and a social sensor.

8. The method for mashing up heterogeneous sensors according to claim 1,
wherein, in said collecting of an activity log from at least one sensor, an activity log is collected periodically from the sensor or collected whenever an activity log is generated from the sensor.

9. The method for mashing up heterogeneous sensors according to claim 1,
wherein, in said collecting of an activity log from at least one sensor, information input by the user is collected.

10. The method for mashing up heterogeneous sensors according to claim 1,
wherein said converting of the collected activity log into a common markup format uses a markup model defining a common markup format.

11. The method for mashing up heterogeneous sensors according to claim 1, further comprising:
storing the activity log converted into the common markup format.

12. The method for mashing up heterogeneous sensors according to claim 1,
wherein the at least one sensor includes at least one of a wearable device, a mobile device, a sensor attached to or included in a wearable device or a mobile device, an application installed at a wearable device or a mobile device, a terminal communicating with a wearable device or a mobile device, a sensor attached to or included in a terminal communicating with a wearable device or a mobile device, and an application installed at a terminal communicating with a wearable device or a mobile device.

13. The method for mashing up heterogeneous sensors according to claim 1, further comprising:
displaying the output activity of the user in a semantic unit.

14. The method for mashing up heterogeneous sensors according to claim 13,
wherein, in said displaying of the output activity of the user in a semantic unit, the output activity is displayed in association with a corresponding application or by means of virtual reality or augmented reality.

15. A computer program, recorded in a recording medium for performing the method for mashing up heterogeneous sensors as defined in the claim 1.

16. An apparatus for mashing up heterogeneous sensors, comprising:
an information collection unit configured to collect an activity log from at least one sensor;
a conversion unit configured to convert the collected activity log into a common markup format;
an activity management unit configured to extract an activity of a user from the activity log, based on an activity model which defines relations among activities; and
an output unit configured to output the extracted activity of the user in a semantic unit.

17. The apparatus for mashing up heterogeneous sensors according to claim 16,
wherein the activity management unit rearranges the activity log in a time order and selects a representative activity of the user from an activity log coexistent in the same time zone.

18. The apparatus for mashing up heterogeneous sensors according to claim 17,
wherein when at least two activity logs are generated in the same time zone, the activity management unit selects a representative activity of the user according to a priority order, which is determined as a criterion for selection of a representative activity, and according to whether activities corresponding to the at least two activity logs are complementary or mutually exclusive.

19. The apparatus for mashing up heterogeneous sensors according to claim 18,
wherein when the activities are complementary, the activity management unit selects the activities as the representative activity and a subsidiary activity of the representative activity.

20. The apparatus for mashing up heterogeneous sensors according to claim 16,
wherein the information collection unit classifies the collected activity log according to a sensor model in which a sensor relationship is defined according to a level of log information.

21. The apparatus for mashing up heterogeneous sensors according to claim 20,
wherein the sensor model classifies the sensor into a physical sensor, an activity sensor and a social sensor.

22. The apparatus for mashing up heterogeneous sensors according to claim 16,
wherein the information collection unit collects an activity log from the sensor periodically or whenever an activity log is generated from the sensor.

23. The apparatus for mashing up heterogeneous sensors according to claim 16,
wherein the information collection unit collects information input by the user.

24. The apparatus for mashing up heterogeneous sensors according to claim 16,
wherein the conversion unit converts the collected activity log into a common markup format by using a markup model defining a common markup format.

25. The apparatus for mashing up heterogeneous sensors according to claim 16, further comprising:
a database configured to storing the activity log converted into the common markup format.

26. The apparatus for mashing up heterogeneous sensors according to claim 16,
wherein the at least one sensor includes at least one of a wearable device, a mobile device, a sensor attached to or included in a wearable device or a mobile device, an application installed at a wearable device or a mobile device, a terminal communicating with a wearable device or a mobile device, a sensor attached to or included in a terminal communicating with a wearable device or a mobile device, and an application installed at a terminal communicating with a wearable device or a mobile device.

27. The apparatus for mashing up heterogeneous sensors according to claim 16, further comprising:
a display unit configured to display the output activity of the user in a semantic unit.

28. The apparatus for mashing up heterogeneous sensors according to claim 27,
wherein the display unit displays the output activity in association with a corresponding application or by means of virtual reality or augmented reality.
